(19) United States
(12) Patent Application Publication
(10) Pub. No.: US 2009/0144152 A1
(43) Pub. Date: Jun. 4, 2009

(54) System of guaranteeing loan repayments at the product level by a split funding method from credit card and online check settled deposits

(75) Inventor: Jimmie Lee Wilson, Agoura Hills, CA (US)

Correspondence Address: Cislo & Thomas LLP, 1333 2nd Street, Suite #500, Santa Monica, CA, 90401-4110, US

(73) Assignee: Terminal Velocity Processing, Inc.

(21) Appl. No.: 12/315,053

(22) Filed: Nov. 26, 2008

Related U.S. Application Data
(60) Provisional application No. 61/004,847, filed on Nov. 30, 2007.

(51) Int. Cl. G06Q 30/00

(52) U.S. Cl. 705/14

(57) ABSTRACT

A system of guaranteeing loan repayments by a split funding method from credit card and online check settled deposits. By split funding transaction deposits, the system provides and tracks a line of credit to the sales representatives. The inventive process: (1) evaluates the sales representative's credit worthiness; (2) approves a line of credit for the sales representative to use in purchasing inventory; (3) ties the liability for the line of credit to the product being sold; (4) accounts for the increases and decreases in the available line of credit as sales representatives purchase items, then repay the line of credit as they sell merchandise; (5) automatically distributes funds to all parties concerned using a prescribed hierarchy when the sales representative sells merchandise; (6) accounts for settling all aspects of customer transactions including commissions, interest, principal repayment, and processing fees; and (7) deposits commissions or net sales proceeds onto the stored value card.

### CROSS-REFERENCES TO RELATED APPLICATIONS

This patent application claims the benefit of U.S. Provisional Patent Application Ser. No. 61/004,847 filed Nov. 30, 2007, for System of Guaranteeing Loan Repayments at the Product Level by a Split Funding Method from Credit Card and Online Check Settled Deposits, which application is incorporated here by this reference.

### TECHNICAL FIELD

This invention relates to systems for distributing funds between entities within a direct marketing or multilevel marketing model.

### BACKGROUND ART

There are thousands of direct marketing organizations (“DMO's”) currently in existence in the United States, with annual U.S. sales exceeding $30 billion and international sales exceeding $100 billion. Companies within this space may be referred to as mail order/telephone order (“MO/TO”), DMO's, multilevel marketing (“MLM”) among others. For purposes of explaining our invention or system, we will use the traditional MLM type organization. In the traditional MLM model, the MLM will recruit independent resellers (“sales representatives”) to proactively promote the MLM's brand versus product sales within a retail store environment. The MLM sells their products to sales representatives at a wholesale cost. Sales representatives then resell those products with their markup. The difference then being the sale representative's profit margin. A majority of sales representatives, which are, for the most part, small owner/home office (“SOHO”) resellers, lack adequate capital requirements to fund and grow their business. For newly recruited, “start-up” sales representatives not having a sales track record or collateral, it is nearly impossible to obtain a business loan through traditional lending institutions. Thus, proportionately very few sales representatives get beyond the barrier to entry funding requirements. The MLM or parent company subsequently spends millions of dollars recruiting and training sales representatives, only to suffer high attrition rates for those sales representatives having a funding shortfall.

Unless the parent companies are able to provide internal financing terms to their sales representatives, it creates a financing line of credit gap that prevents sales representatives from signing on, or contributes to the high attrition rate. This invention proposes to fill that gap by providing sub-prime lending to sales representatives who lack sufficient collateral while affording lenders a guaranty for collecting principal and interest monies from the borrowers' gross sale deposits through a split funding process before a sales representative has access to the money.

### DISCLOSURE OF INVENTION

The present invention is directed to a system of guaranteeing loan repayments by a split funding method from credit card and online check settled deposits. This system lies within a dual phase, multi-step scenario.

Phase I consists of four steps, all of which comprise the loan initiation process. The four steps include: online sales representative registration, lender underwriting approval with loan amount, executed loan agreement, and system updates to reflect a new customer on file. After phase I concludes, sales representatives have an approved credit line to make purchases and conduct business. Although this lending function is preferably performed by a third party institution, the parent company could also self-fund for greater control over the sales representative financing.

Phase II entails a credit card and/or online check transaction between the sales representative and end consumer. This phase is comprised of five steps, with split funding occurring in step five. Beginning with step one, the sales representative consummates a sale; the sales representative accepts a credit card or check as payment for the product; the sales representative requests the parent company to drop ship product to the consumer and pays using line of credit; sales deposits settle into the parent company's centralized checking account; the sales representative and product SKU is systemically identified and monies are split funded to the lender with principal and interest being repaid as well as the commission to the sales representative. In a version of the invention, the sales representative's commissions may be distributed onto a “stored value card,” which eliminates the need for paper commission checks and would further enhance this financing system. A stored value card is a card that can be loaded with funds and functions like a debit card, allowing the sales representative to use the card to make purchases, transfers, and ATM withdrawals.

By split funding transaction deposits, the inventive system provides and tracks a line of credit to the sales representatives. This process authorizes and implements the sales representative's available line of credit for each product purchase, then manages all aspects of every transaction from then on. Taken in its entirety, this unique process accomplishes these functions: (1) evaluates the sales representative's credit worthiness; (2) approves a line of credit for the sales representative to use in purchasing inventory; (3) ties the liability for the line of credit to the product being sold; (4) accounts for the increases and decreases in the available line of credit as sales representatives purchase items, then repay the line of credit as they sell merchandise; (5) automatically distributes funds to all parties concerned using a prescribed hierarchy when the sales representative sells merchandise; (6) accounts for settling all aspects of customer transactions including commissions, interest, principal repayment, and processing fees; and (7) deposits commissions or net sales proceeds onto the stored value card.

This system dramatically reduces MLM attrition, provides a line of credit to sales representatives to fund and grow their business, and furnishes a lender mechanism to mitigate risk by deducting principal and interest before the borrower receives any monies.

Beyond the MLM industry, it is equally contemplated that the system of the present invention can be used for other distribution models, such as franchises, Small Business Administration (SBA) loans, consignment arrangements, as well as professional and social associations. The system is customizable to be used in any organization where the participants would benefit from having payments guaranteed at the product item level.

### BRIEF DESCRIPTION OF DRAWINGS

FIG. 1 is a schematic of an embodiment of a System and Method of Guaranteeing Loan Repayment at the Product Item Level Using Split Funding for Payment of Product Purchases.

FIG. 2 is a chart showing the services of the split fund guarantor in a version of the invention.

FIG. 3 is a flowchart of a transaction of initiating the sales representative's available credit for a version of the invention.

FIG. 4 is a flowchart of a transaction of field representative purchases for a version of the invention.

FIG. 5 is a flowchart of a transaction of field representative sales for a version of the invention.

FIG. 6 is a chart showing the transfer of funds for a version of the invention.

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

Referring to the figures, the split fund guarantor 10 facilitates the interactions between a network marketing organization or multilevel marketer (MLM) 20, a sales representative 30, and customers 40.

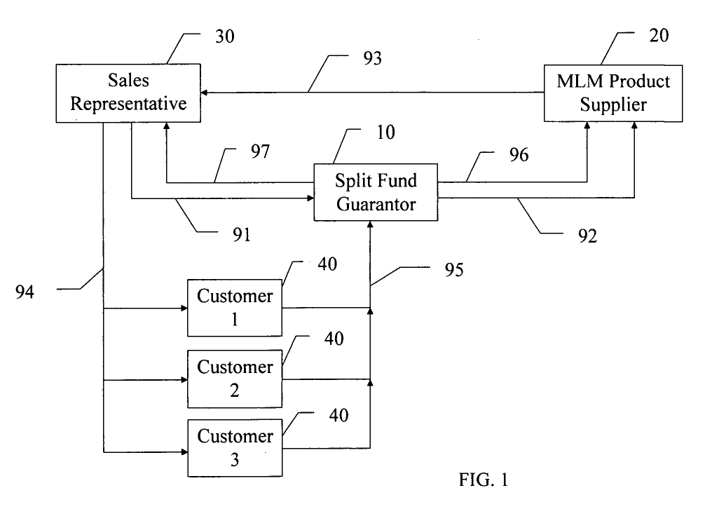

FIG. 1 depicts the relationship between the split fund guarantor 10, the MLM product supplier 20, the sales representative 30, and the customers 40 in a version of the invention. The arrow 91 shows the flow of information regarding creditworthiness from the sales representative 30 to the split fund guarantor 10. The arrow 92 shows the financial guarantee made by the split fund guarantor 10 to the MLM product supplier 20. The flow of product from the MLM 20 to the sales representative 30 is depicted by the arrow 93, while the product flow from the sales representative 30 to the customers 40 is shown by arrows 94. Arrows 95 depict the flow of funds from the customers to the split fund guarantor 10. Arrow 96 shows the split funds portion for the MLM 20, while arrow 97 shows the split funds portion to the sales representative 30. The transfer of data depicted in FIG. 1 preferably occurs via an interactive gateway, depicted graphically by the arrows in the figure. The gateway may be accessed by way of one or more terminals operable by the split fund guarantor 10, the sales representative 30, the MLM product supplier 20, or the customers 40.

Consequently, the sales representative 30 preferably need only concentrate on selling the product. The split fund guarantor 10 handles the financial transactions with the MLM 20 and the customer 40. This system is beneficial since it may provide a turnkey solution for the sales representative 30 or for MLMs 20 with minimal infrastructure. The funding preferably comes from a third-party financer, although the split fund guarantor 10 could provide funding from its assets in versions of the invention.

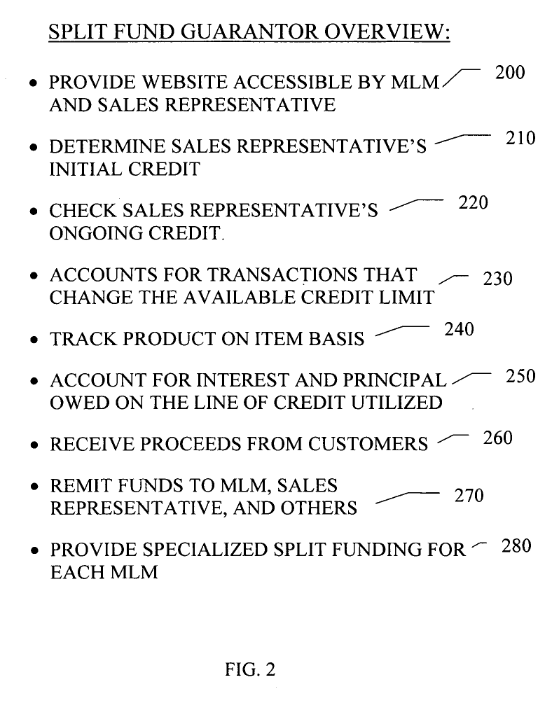

Referring to FIG. 2, in a preferred version of the invention, the split fund guarantor 10 provides a website or other gateway that is accessible by the MLM 20 and the sales representative 30 (step 200); determines the initial creditworthiness of the sales representative 30 (step 210); checks the ongoing credit of the sales representative 30 (step 220); accounts for transactions that increase and decrease the sales representative's available credit limit (step 230); tracks product transferred to the sales representative 30 on an item basis (step 240); accounts for interest and principal owed by the sales representatives on the line of credit utilized (step 250); receives proceeds from the customers 40 (step 260); and remits funds to the MLM 20, the sales representative 30, and to all those in the network marketing up-line entitled to compensation based on the sale by the sales representative 30 (step 270). In addition, the split fund guarantor 10 may provide specialized or customized split funding for each MLM 20 (step 280).

In a typical scenario, the sales representative 30 approaches the MLM 20 with a desire to sell the products of the MLM 20. The MLM implemented the split fund guarantor and the sales representative elected to the use the services provided by the split fund guarantor. The split fund guarantor 10 provides a financial guarantee to the MLM 20 for the cost of each product item sought to be obtained by the sales representative 30 for the purpose of selling the product item to a customer 40. Since the liability for the line of credit is tied to each product item, the product item is the collateral for the line of credit. This permits the sales representative 30 to take possession of each product item without providing the MLM 20 with any upfront monies. The split fund guarantor 10 pays the MLM 20 for the cost of the product, eliminating the need for the sales representative to furnish the cost of inventory upfront. The sales representative 30 may then sell the product item to a customer 40. The customer 40 remits the purchase price of the product item to the split fund guarantor 10, and the split fund guarantor 10 divides the remitted purchase price to the appropriate parties. This division may be by predetermined algorithm, and it may be customizable for each MLM 20. Additionally, the split fund guarantor 10 may keep a portion of the remitted purchase price as its fee for service.

Throughout the process, each product item may be tracked by the split fund guarantor. Such tracking information might include, for example, the physical location of the product item, whether it has been sold to a customer 40, and whether the MLM has been reimbursed the cost of the product item. Such tracking is particularly helpful where the liability for the line of credit is tied to each product item.

Additionally, the split fund guarantor 10 may be able to debit a personal account of the sales representative 30, such as a checking account or savings account, for the amounts owed the MLM 20 and the split fund guarantor 10.

The guaranteeing repayment system also enables transactions to be executed over the Internet or telephone, for example, via a website or an interactive voice recognition system (IVR).

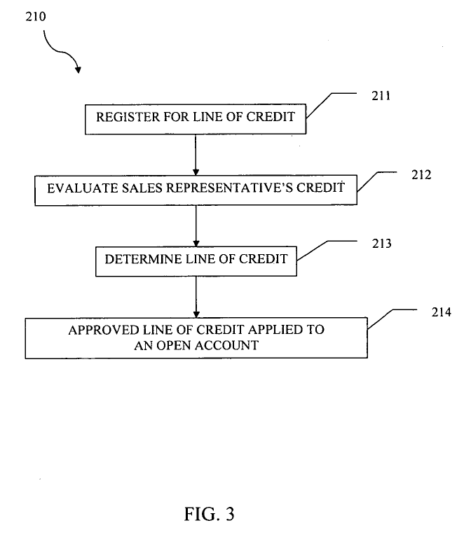

The sales representative's available credit represents the allowable purchases by a sales representative of approved items from the MLM. Referring to FIG. 3, to initiate the sales representative's available credit (step 210), the sales representative 30 registers or applies for a line of credit (step 211). Next, the sales representative's creditworthiness is evaluated (step 212), and a line of credit is determined (step 213). The sales representative's credit may be evaluated by, for example, a credit evaluation company. The credit evaluation company may then match the credit application against the split fund guarantor's predetermined credit criteria. The credit criteria may consider, among other things, FICO scores, address verification, validation of a bank account, and validation of government issued identification. In step 214, the amount of credit granted the sales representative goes into an open account.

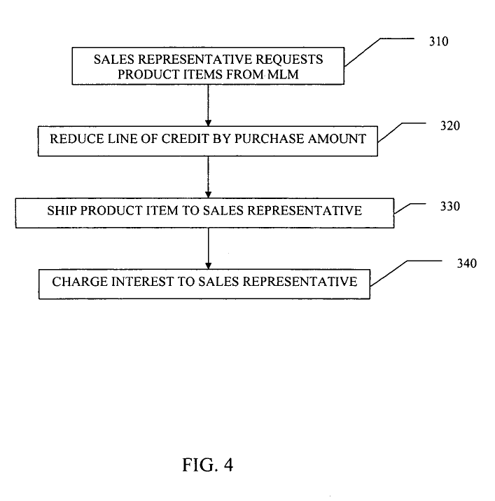

FIG. 4 shows the typical events when the sales representative 30 buys product items from the MLM 20, as depicted from the sales representative's perspective. This begins by the sales representative requesting product items from the MLM 20 (step 310). The sales representative's line of credit is then reduced by the cost of the items purchased (step 320). In step 330, the product items are transferred to the sales representative, the split fund guarantor transfers funds to the MLM in the amount of the purchase, and in step 340, interest begins to be charged to the sales representative on the amount of the line of credit being used.

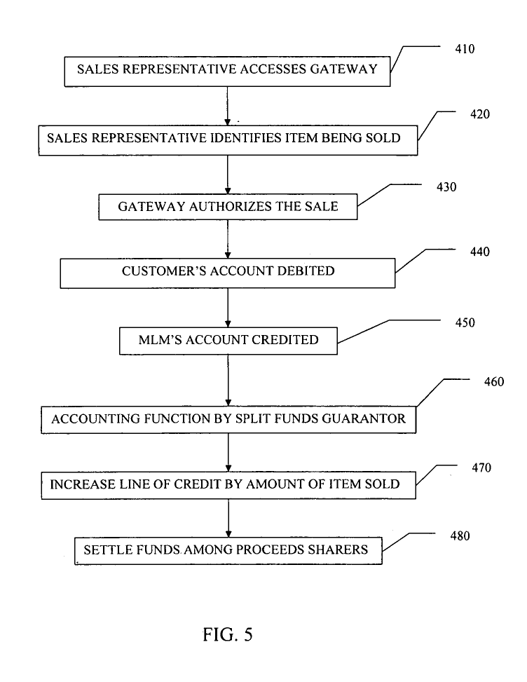

FIG. 5 depicts the activities when the sales representative makes a sale to a customer. To begin, the sales representative accesses a gateway, for example, using either a computer terminal linked to the Internet, an IVR system, a POS system, a POS terminal, or a microsite (step 410). The gateway passes the transactions on to an authorization processor that performs the authorization procedures per the industry rules and regulations 40. The authorization processor may be a third party processing center. Periodically (preferably at the end of the business day), the processor sends a transaction settlement file containing all transactions that have been authorized to initiate movement of funds from the customer's account to an account specified by the split fund guarantor 10.

In step 420, the sales representative identifies the item being sold, and the gateway authorizes the sale in step 430.

The flow of funds may occur as follows. In step 440 the customer is debited for the entire purchase amount, by debiting an account accessible to the split fund guarantor 10. The MLM 20 is credited for the entire cost of the product item in step 450 by crediting an account accessible to the split fund guarantor 10. Next, the MLM 20 performs an accounting function (step 460), where fund splitting protocols are based on a product identifier, such as a stock keeping unit (SKU), and any agreement between the sales representative 30, the MLM 20, or the split fund guarantor 10. Step 470 increases the sales representative's available credit by the cost of the item sold. Then, funds are settled with all who share in the proceeds (step 480). The following funds settlements occur, preferably in the order presented: (a) accumulated interest; (b) all processing fees; (c) principal borrowed attributed to the item sold; and (d) commission due to the sales representative 30 or others from the sale of the item.

The processing fees may be calculated as a contractually agreed on percentage of the sales amount. These fees are paid by the MLM 20 to the split fund guarantor 10 as compensation for authorizing and settling the transaction on behalf of the MLM 20. Alternatively, such fees might be paid by the sales representative 30. Fees can be paid and settled at the conclusion of each transaction or they can be accumulated and then periodically paid in a lump sum, such as at the end of the month.

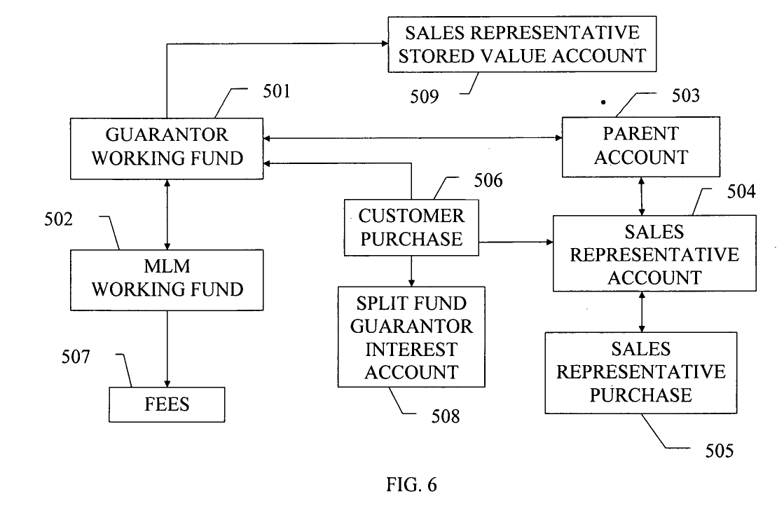

Referring to FIG. 6, from a fund-transfer perspective, the system might operate as follows. A guarantor working fund 501 is the repository for all funds available to the split fund guarantor 10 for distribution to the MLM 20. The guarantor working fund 501 is diminished periodically by the amount of sales representative purchases funded and replenished periodically by the amount of sales representative sales. Preferably, the period for diminishment and replenishment is daily, and most preferably in real-time.

In one version of the invention, an amount equivalent to the cost of the product item is not paid to the MLM 20 until the sales representative 30 has made a sale of the product item to a customer 40. As such, the split fund guarantor 10 remains a guarantor of the amounts owed to the MLM 20, without actually having to transfer that amount to the MLM 20 until compensation is received from the end customer 40.

An MLM working fund 502 is a working account which, when utilized, retains enough funds to ensure no shortfalls when transacting business with the guarantor working fund 501. The MLM working fund 502 may be particularly beneficial in those versions of the invention where the MLM 20 desires to be paid for the cost of the product item upon transfer of the product item to the sales representative 30 or to the end consumer 40.

The MLM working fund 502 is paid into from the guarantor working fund 501 when a sales representative 30 purchases product from the MLM 20 by crediting an amount equivalent to some or the entire purchase price. This helps to ensure that the MLM 20 recoups the cost of the product item and its transaction fees (both reflected in the purchase price to the sales representative) for the product without directly impacting the sales representative 30. The MLM working fund 502 pays the guarantor working fund 501 when the sales representative sells product and thus recoups the cost of the product item and the original transaction fees from the customer 40.

The parent account 503 is a virtual account entity defining the maximum funds that can be called for from the guarantor working fund 501. This maximum can be increased or decreased depending on the needs of the MLM 20, the sales representative 30, and the availability of funds.

A sales representative account 504 is a subset of the parent account 503. The available amount in the sales representative account 504 may be determined by a profile for the sales representative 30, where the profile may be based on credit-scoring, the history of the sales representative 30 with the MLM 20, or the history of the sales representative with the split fund guarantor 10. When the sales representative 30 completes a purchase or sale, the sales representative account 504 is debited or credited, respectively, for the product movement, as is the parent account 503, and a movement of funds is initiated between the guarantor working fund 501 and the MLM working fund 502.

A sales representative purchase 505 occurs when the sales representative 30 buys a product item from the MLM 20. A transaction record is created with unique order identification for tracking the movement of the unit purchased, and the transaction record is date stamped to begin the clock for finance charges related to the use of the line of credit. A transaction fee may be calculated based on the purchase price, and funds are moved from the guarantor working fund 501 to the MLM working fund 502 for the cost of the product item. The purchase initiates the updating of the parent account 503 and the sales representative account 504.

A customer purchase 506 occurs when the sales representative sells the product to the customer 40 or end-user. Funds are extracted from the customer's credit or checking account and moved to the MLM working fund 502. The system initiates a table look up (TLU) to access the data related to the order identification and extracts the amount of the cost of the product item plus the original transaction fees and the original purchase date. The revenue from the customer purchase 506 may be used to calculate the transaction fees for all appropriate parties, and funds are distributed to the fees account 507 from the MLM working fund 502. The cost of the product item, purchase date, and sale date are used to calculate the appropriate finance charges, and the fees are distributed to a split fund guarantor interest account 508. The cost of the product item plus any transaction fees are then subtracted from the remaining amount and credited to the parent account 503 and the sales representative account 504, initiating the movement of funds from the MLM working fund 502 to the guarantor working fund 501. After the cost of the product item plus transaction fees, the fees account 507 and the split fund guarantor interest account 508 are each subtracted from the revenue. The remainder, or commission, is credited to the sales representative stored value account 509 from the MLM working fund 502.

The order identification data may be merged with any available customer information accumulated at the time of sale to create a database for customer targeted marketing and redistribution of customers to sales representatives.

A method of guaranteeing loan repayments at the product level by a split funding method from credit card and online check settled deposits involves providing a gateway accessible to a multilevel marketer and a sales representative; determining an initial creditworthiness of the sales representative; accounting for transactions that increase and decrease the granted amount of credit; receiving information via the gateway that the sales representative requested a product from the multilevel marketer, the requested product having a requested product cost; transmitting financial guarantee information to the multilevel marketer; reducing the granted amount of credit by the requested product cost; tracking the requested product on an item basis and providing tracking information; receiving information via the gateway of a customer product request, identifying the requested product requested; authorizing the customer product request and notifying the sales representative of the authorized product, the authorized product having a customer product cost; debiting a customer account associated with the customer for an amount equivalent to the customer product cost; increasing the granted amount of credit by an amount equivalent to the customer product cost; accounting for interest of the granted amount of credit, the interest being based on the requested product cost; debiting a personal account of the sales representative for an amount owed the multilevel marketer and the split fund guarantor; receiving funds information from the customer; transmitting a first split funds portion to the multilevel marketer; and transmitting a second split funds portion to the sales representative.

In this method, the gateway is typically an interactive internet website, a telephonic interactive voice recognition system, or a touch-tone interactive system.

Additionally, the step of determining an initial creditworthiness of the sales representative typically includes the steps of registering the sales representative for a line of credit through a credit application via the gateway; evaluating a basic creditworthiness by matching the credit application against predetermined credit criteria, the credit criteria including FICO scores, address verification, validation of a bank account, and validation of government issued identification; and granting an amount of credit to the sales representative and crediting an open account with that amount.

The system can take the form of an entirely hardware embodiment, an entirely software embodiment, or an embodiment containing both hardware and software elements. In one embodiment, the system is implemented in software, which includes but is not limited to firmware, resident software, microcode, etc.

Furthermore, the system can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium comprise a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

Described above, aspects of the present system are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. The Internet can include a plurality of local area networks (“LANs”) and a wide area network (“WAN”) interconnected by routers. The routers are special purpose computers used to interface one LAN or WAN to another. Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines, or other communications links known to those skilled in the art.

Furthermore, computers and other related electronic devices can be remotely connected to either the LANs or the WAN via a digital communications device, modem and temporary telephone, or a wireless link. It will be appreciated that the Internet comprises a vast number of such interconnected networks, computers, and routers.

As is appreciated by those skilled in the art, the WWW is a vast collection of interconnected or “hypertext” documents written in HyperText Markup Language (“HTML”), or other markup languages, that are electronically stored at or dynamically generated by “WWW sites” or “Websites” throughout the Internet. Additionally, client-side software programs that communicate over the Web using the TCP/IP protocol are part of the WWW, such as JAVA® applets, instant messaging, e-mail, user agent plug-ins, Macromedia Flash, chat and others. Other interactive hypertext environments may include proprietary environments such as those provided in America Online or other online service providers, as well as the “wireless Web” provided by various wireless networking providers, especially those in the cellular phone industry. It will be appreciated that the present application could apply in any such interactive communication environments; however, for purposes of discussion, the Web is used as an exemplary interactive hypertext environment.

A Website is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a Website elsewhere on the Internet. Each hyperlink is assigned a Uniform Resource Locator (“URL”) that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs, such as application programs written in the JAVA® programming language from Sun Microsystems, for execution on a remote computer. Likewise, a web server may also include facilities for executing scripts and other application programs on the web server itself.

A remote access user may retrieve hypertext documents from the World Wide Web via a user agent program. A user agent, such as Netscape's NAVIGATOR®, Microsoft's INTERNET EXPLORER®, or Mozilla Foundation's FIREFOX®, is a software application program for providing a user interface to the WWW. Upon request from the remote access user via the user agent, the user agent requests the desired hypertext document from the appropriate web server using the URL for the document and the HyperText Transport Protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The user agent may also retrieve programs from the web server, such as JAVA applets, for execution on the client computer. Finally, the user agent may include optional software components, called plug-ins, that run specialized functionality within the user agent.

While the present invention has been described with regards to particular embodiments, it is recognized that additional variations of the present invention may be devised without departing from the inventive concept. In particular, the system could also be used for other distribution systems or consignment arrangements, and it could be used by franchisors as well as professional and social associations. Additionally, the system discussed may be customizable to provide as many or as few elements as suits a particular application. For example, organizations having little or no infrastructure might benefit from more of the modules than organizations with more extensive systems in place. In addition, each account, whether described as physical account or a virtual account, could be a physical account or a virtual account in variations of the invention.

### INDUSTRIAL APPLICABILITY

This invention may be industrially applied to the establishment and management of systems for distributing funds between entities within a direct marketing organization or multilevel marketing model.

What is claimed is:

1. A system for guaranteeing loan repayments, the guaranteeing system comprising:
(a) An interactive gateway;
(b) a sales representative terminal coupled to the interactive gateway and operable by a sales representative, the sales representative terminal accepting creditworthiness information;
(c) at least one customer terminal coupled to the interactive gateway and operable by the sales representative or a customer, the at least one customer terminal accepting funds information; and
(d) a split fund guarantor transmitting and receiving information over the interactive gateway and interacting with a product supplier terminal operable by a product supplier, wherein the split fund guarantor receives creditworthiness information from the sales representative terminal, transmits financial guarantee information to the product supplier, the financial guarantee information based on the creditworthiness information, receives information that the product supplier confirmed a product to the sales representative, receives information that the sales representative confirmed a product to the customer, and receives funds information from the customer; the split fund guarantor transmitting a first split funds portion to the product supplier, and transmits a second split funds portion to the sales representative.

2. The system for guaranteeing loan repayments of claim 1, wherein the interactive gateway comprises an internet website.

3. The system for guaranteeing loan repayments of claim 1, wherein the interactive gateway comprises a voice recognition system.

4. The system for guaranteeing loan repayments of claim 1, wherein the interactive gateway comprises a touch-tone interactive system.

5. A computer readable medium storing instructions for causing at least one processor to perform a method for guaranteeing loan repayments by a split fund guarantor, the method comprising:
(a) providing a gateway accessible to a multilevel marketer and a sales representative, the gateway being selected from the group consisting of an interactive internet website, a telephonic interactive voice recognition system, and a touch-tone interactive system;
(b) determining an initial creditworthiness of the sales representative by:
(i) registering the sales representative for a line of credit through a credit application via the gateway;
(ii) evaluating a basic creditworthiness by matching the credit application against predetermined credit criteria, the credit criteria including FICO scores, address verification, validation of a bank account, and validation of government issued identification; and
(iii) granting an amount of credit to the sales representative and crediting an open account with that amount;
(c) accounting for transactions that increase and decrease the granted amount of credit;
(d) receiving information via the gateway that the sales representative requested a product from the multilevel marketer, the requested product having a requested product cost, the information including a product SKU number;
(e) transmitting financial guarantee information to the multilevel marketer, the financial guarantee information being based on the creditworthiness information and guaranteeing the requested product cost, the requested product being collateral for the guarantee, the financial guarantee information including funds equivalent to the requested product cost;
(f) reducing the granted amount of credit by the requested product cost;
(g) tracking the requested product on an item basis using the product SKU number and providing tracking information, the tracking information including the physical location of the requested product, whether the requested product is sold to the customer, and whether the multilevel marketer is reimbursed for the requested product;
(h) receiving information via the gateway of a customer product request, identifying the customer requested product, the information including the product SKU number;
(i) authorizing the customer product request and notifying the sales representative of the authorized product, the authorized product having a customer product cost;
(j) causing a customer account associated with the customer to be debited an amount equivalent to the customer product cost;
(k) increasing the granted amount of credit by an amount equivalent to the customer product cost;
(l) accounting for interest of the granted amount of credit, the interest being based on the requested product cost and a period of elapsed time;
(m) causing a sales representative account associated with the sales representative to be debited an amount owed the multilevel marketer and the split fund guarantor;
(n) receiving funds information originating from the customer;
(o) transmitting a first split funds portion to the multilevel marketer, the first split funds portion being determined by a predetermined agreement between the split fund guarantor and the multilevel marketer;
(p) transmitting a second split funds portion to the sales representative; and
(q) retaining a processing fee.

6. A system comprising a server connected to a network, the server transmitting and receiving information over the network, the server comprising at least one processor, a database for storing account and product information, and a memory operatively coupled to the processor, the memory storing program instructions that when executed by the processor, causes the processor to:
(a) provide a gateway over the network accessible to a multilevel marketer and a sales representative;
(b) determine an initial creditworthiness of the sales representative;
(c) account for transactions that increase and decrease the granted amount of credit;
(d) receive information via the gateway that the multilevel marketer supplied a product to the sales representative, the requested product having a requested product cost;
(e) transmit financial guarantee information to the multilevel marketer;
(f) reduce the granted amount of credit by the requested product cost;
(g) track the requested product on an item basis and providing tracking information;
(h) receive information via the gateway of a customer product request, identifying the customer requested product;
(i) authorize the customer product request and notifying the sales representative of the authorized product, the authorized product having a customer product cost;
(j) causing a customer account within the database associated with the customer to be debited an amount equivalent to the customer product cost;
(k) increase the granted amount of credit by an amount equivalent to the customer product cost;
(l) account for interest of the granted amount of credit, the interest being based on the requested product cost and an elapsed time;
(m) causing a sales representative account associated with the sales representative to be debited an amount owed the multilevel marketer and the split fund guarantor;
(n) receive funds information from the customer;
(o) transmit a first split funds portion to the multilevel marketer; and
(p) transmit a second split funds portion to the sales representative.

7. The method of claim 6, the gateway being selected from the group consisting of an interactive internet website, a telephonic interactive voice recognition system, and a touch-tone interactive system.

8. The method of claim 6, the step of determining an initial creditworthiness of the sales representative comprising the steps of:
(a) registering the sales representative for a line of credit through a credit application via the gateway;
(b) evaluating a basic creditworthiness by matching the credit application against predetermined credit criteria, the credit criteria including FICO scores, address verification, validation of a bank account, and validation of government issued identification; and
(c) granting an amount of credit to the sales representative and crediting an open account with that amount.

9. The method of claim 6, the financial guarantee information transmitted to the multilevel marketer being based on the creditworthiness information and guaranteeing the requested product cost, the requested product being collateral for the guarantee, the financial guarantee information including funds equivalent to the requested product cost.

10. The method of claim 6, the tracking information including the physical location of the requested product, whether the requested product is sold to the customer, and whether the multilevel marketer is reimbursed for the requested product.

11. The method of claim 6, the first split funds portion being determined by a predetermined agreement between the split fund guarantor and the multilevel marketer.

12. The method of claim 6 further comprising the step of the allocating a processing fee to the split fund guarantor.

13. The method of claim 6, the information received via the gateway that the multilevel marketer supplied a product to the sales representative including a product SKU number.

14. A computer-implemented method for guaranteeing loan repayments using a split fund guarantor, the method comprising:
(a) providing a guarantor working fund, the guarantor working fund being the repository for all funds available to a split fund guarantor for distribution to a multilevel marketer;
(b) funding a sales representative purchase having an amount of sales representative purchases funded;
(c) receiving a sales representative sale having an amount of sales representative sales;
(d) periodically diminishing the guarantor working fund by the amount of sales representative purchases funded;
(e) periodically replenishing the guarantor working fund by an amount of sales representative sales, the period being in real-time with the receipt of the sales representative sales;
(f) providing a multilevel marketer fund, the multilevel marketer fund retaining funds to ensure no shortfalls when transacting business with the guarantor working fund;
(g) crediting the multilevel marketer fund by an amount equivalent to a product purchase price;
(h) paying into the multilevel marketer fund by the guarantor working fund in an amount equivalent to the product purchase price;
(i) providing a parent account, the parent account being a virtual account defining a maximum amount of funds that can be called for from the guarantor working fund;
(j) providing a sales representative account, the sales representative account being a subset of the parent account, the amount in the sales representative account being determined by a sales representative profile, the sales representative account being debited or credited, respectively, when the sales representative completes a product purchase or a product sale;
(k) purchasing of a product item from the multilevel marketer by the sales representative, defining a sales representative purchase;
(l) creating a transaction record, the transaction record having an order identification for tracking the movement of the product item, the transaction record also having a date stamp;
(m) assessing a transaction fee based on the product purchase price;
(n) selling the product item to a customer at a product sales price by the sales representative, defining a customer purchase,
(o) transferring funds from an account of the customer to the multilevel marketer fund;
(p) initiating a table look-up to access order identification data, the order identification data including the transaction record, the product purchase price, the transaction fee, the product sales price, a purchase date, and a sale date;
(q) transferring the assessed transaction fee to a fees account from the multilevel marketer fund;
(r) calculating a finance charge based on the product purchase price, purchase date, and sale date;
(s) distributing the calculated finance charge to a split fund guarantor interest account;
(t) crediting to the parent account and the sales representative account the product purchase price and transaction fees, thereby initiating a movement of funds from the multilevel marketer fund to the guarantor working fund;
(u) calculating a sales representative commission; and
(v) crediting the sales representative commission to a sales representative stored value account from the multilevel marketer fund.

15. The computer-implemented method of claim 14, the periodic diminishing of the guarantor working fund by the amount of sales representative purchases funded being in real-time with the funding of the sales representative purchase.

16. The computer-implemented method of claim 14, the periodic replenishing the guarantor working fund by an amount of sales representative sales being in real-time with the receipt of the sales representative sales.

17. The computer-implemented method of claim 14, the maximum amount of funds that can be called for from the guarantor working fund being variable.

18. The computer-implemented method of claim 14, the step of calculating a sales representative commission considering the product purchase price, the product sales price, the transaction fee, and the finance charge.
